(19) United States
(12) Patent Application Publication
(10) Pub. No.: US 2008/0209316 A1
(43) Pub. Date: Aug. 28, 2008

(54) SYSTEM AND METHOD OF IMPLEMENTING AN EXTENSIBLE COMMAND-LINE INTERFACE

(75) Inventor: Matt ZANDSTRA, San Francisco, CA (US)

Correspondence Address: Yahoo! Inc., c/o Kenyon & Kenyon LLP, 333 W. San Carlos Street, Suite 600, San Jose, CA, 95110, US

(73) Assignee: YAHOO! INC., Sunnyvale, CA (US)

(21) Appl. No.: 11/679,796

(22) Filed: Feb. 27, 2007

(51) Int. Cl. G06F 3/048

(52) U.S. Cl. 715/700

(57) ABSTRACT

A system and method of implementing an extensible command-line interface may be employed to extend a command-line application. In accordance with one aspect, a plug-in management engine may define a contract that allows access to a command-line interface and may allow plug-ins honoring the contract to interface with the command-line application through the interface.

### BACKGROUND

1. Field of the Invention

Aspects of the present invention relate generally to supplementing core functions of a computer program, and more particularly to a system and method that may employ a plug-in architecture to supplement the functionality of an application via an extensible command-line interface.

2. Description of Related Art

Employing conventional methodologies, a computer programmer or software developer wishing to build a command-line application or plug-in functionality to perform a specified task must both: write the core functions for the application or plug-in; and build a command-line command to invoke the component and to initialize or otherwise to control its operation (e.g., through flag settings, parameter definitions, and the like). For both of these tasks, the programmer or developer is likely to use a high-level compiled programming language such as C. Other types of application programs or components require similar tasks, and are generally written in high-level languages. It would be desirable to provide a simplified technique that leverages object-oriented programming efficiencies and plug-in architectures to facilitate development of complex application software for command-line applications and other contexts.

In that regard, object-oriented programming techniques seek to generate applications that employ extensible and switchable (or swappable) components; many application programs and other software code are created with extensibility and swappability as specific goals. On the other hand, even if successfully integrated into an application when it is created, extensibility and swappability are difficult to support beyond the initial design of a system. Components or modules are often hard-coded, for example, within the application source code or in package definition files. Even when such applications are constructed to be extensible in theory, it is often difficult for engineers to modify the code, and thus the features of the application, in practice.

By way of example, a computer application program may be designed selectively to output information to plain text, to HyperText Markup Language (HTML), and to Database Management (DBM) files, either independently or in combination. To achieve this flexibility, an object-oriented programmer or developer may generally create an abstract Output class with specializations for each supported format. In theory, extending the functionality of the application to support a new output (e.g., to eXtensible Markup Language (XML)) is a simple matter involving extension of the Output class; again, in theory, this is easily accomplished by writing a new specialization. In practice, however, most software development projects and software applications are not set up to enable enhancements to be implemented easily, and on a “want-it-now” basis. A software developer working with a team may submit a modified version of the Output class (e.g., supporting XML output) for review (e.g., by management, by other team members, or both) and inclusion in the next release of the application or development tool, which can mean a delay of weeks or months; alternatively, the developer may amend or otherwise alter a local installation, but only at the cost of branching from the project and working with a version of the application or development tool that is different from that used by other team members.

Extensibility is generally offered only on a case-by-case basis as approved by those having authority to do so, and importantly, only at predetermined extension points. By way of example: a text editor application may be extended to support different output formats or different symbols (such as an Asian language package, for instance); a photograph editing application may be extended to accommodate use of a custom filter or color matching software; a media player application may be extended to recognize new input formats; blog packages may often be extended to work in conjunction with enhanced presentation layer software packages; and so forth. Traditional extensibility strategies work because only a few points at which the application may be extended are clearly defined. While allowing third parties to prepare compatible plug-in components that integrate well with a particular application, these strategies also, by design, create a significant limitation on the overall extensibility of the application—only certain functionality may be added. While a text editor may be extended to recognize Chinese characters, for example, it may not be extended to recognize graphics or video input formats, if appropriate extension points supporting such input were not specifically defined when the text editor was created.

In many instances, it would be desirable to provide a method and system that enable a programmer or software developer to define extension points such that plug-ins may be created selectively to add a desired functionality at any point in a command-line application. Such a method and system may employ a simple framework enabling a developer to build a command-line application or plug-in and to connect it to core functions written in a simple, interpreted (i.e., not compiled) language. By obviating the need for a compiled language, such a framework may enable a wider range of programmers to build, maintain, and extend command-line applications.

### SUMMARY

Embodiments of the present invention overcome the above-mentioned and various other shortcomings of conventional technology, providing a system and method of implementing an extensible command-line interface to extend a command-line application. In accordance with one aspect, a plug-in management engine may define a contract that allows access to a command-line interface and may allow plug-ins honoring the contract to interface with the command-line application; in the foregoing manner, a method of implementing an extensible command-line interface to extend an application may employ a robust and readily extensible plug-in architecture.

The foregoing and other aspects of various embodiments of the present invention will be apparent through examination of the following detailed description thereof in conjunction with the accompanying drawing figures.

### BRIEF DESCRIPTION OF THE DRAWING FIGURES

FIG. 1 is a simplified diagram illustrating one embodiment of a component of a computer application.

FIG. 2 is a simplified diagram illustrating one embodiment of an interface between a host component and an extender plug-in.

FIG. 3 is a simplified diagram illustrating additional interfaces between host components and extender plug-ins.

FIG. 4 is a simplified block diagram illustrating one embodiment of a command-line interface system.

FIG. 5 is a simplified block diagram illustrating one embodiment of a command-line interface component employing extender components.

FIG. 6 is a simplified block diagram illustrating one embodiment of a plug-in architecture for use in conjunction with an extensible command-line interface.

FIG. 7 is a simplified diagram illustrating execution of one embodiment of a command-line interface command.

FIG. 8 is a simplified flow diagram illustrating operation of one embodiment of a method of implementing an extensible command-line interface.

### DETAILED DESCRIPTION

### Introduction

Aspects of the present invention are described below in the context of employing a flexible plug-in management engine in the development of a command-line application implementing a command-line interface (CLI). As set forth in detail below, an “agnostic” plug-in management engine may extrapolate existing concepts in plug-in architecture to enable a new (or existing) command-line application to be extended to include additional functions. It will be appreciated that the disclosed framework is not intended to be limited to command-line applications, and that embodiments of a plug-in management engine may facilitate extension of other types of computer application programs without inventive faculty.

Those of skill in the art will appreciate that a plug-in framework may be enabled to maintain a network of individual files, each of which may generally be written in an interpreted language such as JAVA™, PERL™, PHP HyperText Preprocessor (PHP)™, and others. The present disclosure is not intended to be limited with respect to the language in which any particular plug-in or other component is authored. The files defining plug-in characteristics and operational behaviors may be created in such a way as to require that each plug-in honor a contract to provide parent-child relationships with each other, for instance, and that each plug-in application honor an interface between the plug-in management engine CLI and the parent application.

In that regard, a “plug-in” is generally understood to represent a particular component type or class that can be “plugged in” or otherwise executed at runtime to enhance a parent component—the parent component may be an application program, for example, or it may be a plug-in itself. For proper operation, a plug-in typically announces (or defines) the parent component it commits to enhance, and in doing so, it must generally commit to fulfill (or otherwise to “honor”) a contract defined by that parent component. One way to constrain a plug-in is to require that it implement an interface. This interface (or other constraint enforced by the parent) is typically referred to as an “extension point.” An application (or parent plug-in) might define several such extension points at which a plug-in may provide additional functionality. Where a plug-in enhances or supplements the functionality of a parent component in this way, it is sometimes referred to as an “extender,” “extending,” or “helper” plug-in, whereas the component it enhances may generally be referred to as a “host” component (i.e., either a host application or host plug-in).

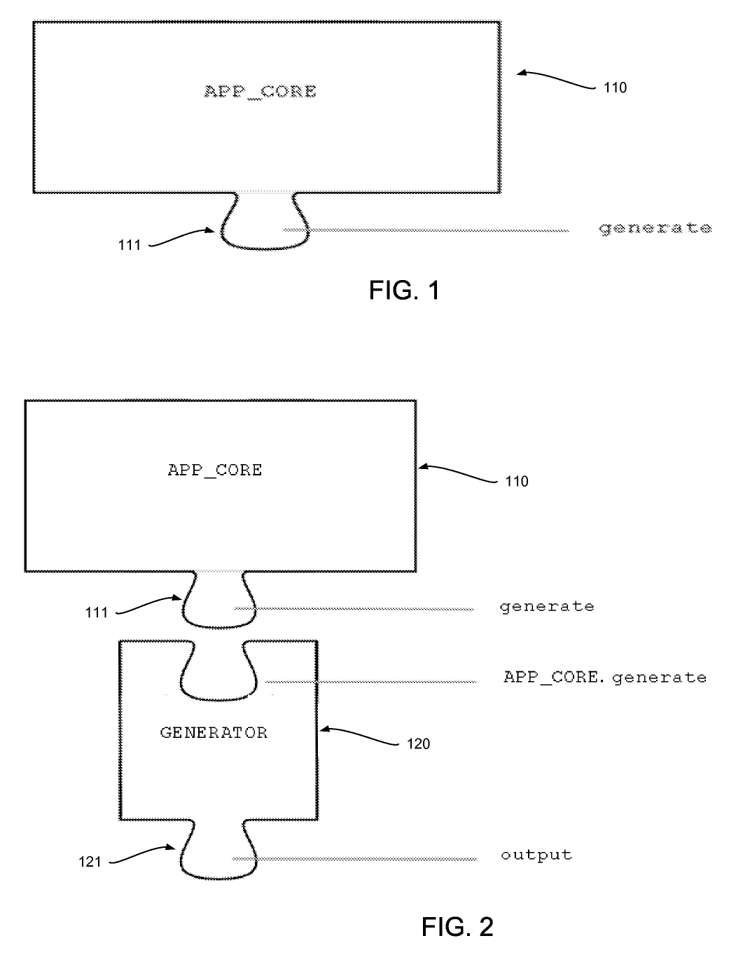

FIG. 1 is a simplified diagram illustrating one embodiment of a component of a computer application, and FIG. 2 is a simplified diagram illustrating one embodiment of an interface between a host component and an extender plug-in.

As illustrated in the drawing figures, an APP_CORE component 110 (which may be a computer application program or a plug-in itself) offers a single extension point 111, labeled “generate.” As noted above, and particularly in interpreted languages such as PHP and JAVA™, interfaces may be employed to define extension points. The generate extension point 111 in FIGS. 1 and 2 may be expressed in PHP as follows:

<?php
interface generate {
function generate( app_Context $context );
}
?>

As noted above, different languages may be employed to define an extension point, and the foregoing is provided by way of example only, and not by way of limitation.

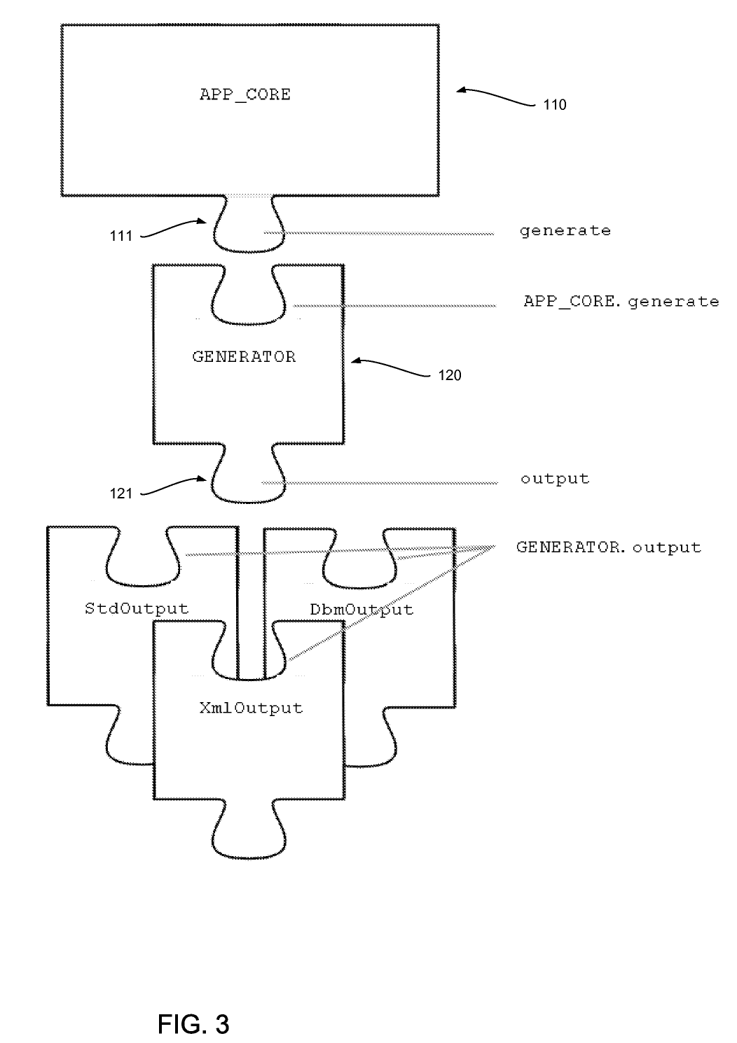

In order to take advantage of the “generate” functionality, parent component APP_CORE 110 may identify a suitably coded object to fulfill extension point 111, i.e., to commit to honoring a defined contract. As indicated in FIG. 2, a GENERATOR plug-in 120 may be designed to take advantage of extension point 111. Those of skill in the art will appreciate that plug-in 120 also defines its own extension point 121, labeled “output.” A programmer, developer, or other user may create a plug-in that is designed to honor the contract defined by this “output” extension point 121, and a plug-in management engine may make that functionality available to the host component or components, i.e., in this case both GENERATOR plug-in 120 and host APP_CORE 110. This is illustrated in FIG. 3, which is a simplified diagram illustrating additional interfaces between host components and extender plug-ins.

While, as noted above, a plug-in is generally thought of as a particular type or class in object-oriented programming, extension points, helper classes, and configuration files are also elements that may contribute to supplementing the functionality or operating characteristics of a component. In that regard, while the term “plug-in” may typically refer to a class, it may be applied more generally to a directory or archive that contains the files related to a particular component's task. In many instances, it may be desirable to group several related plug-ins into a single plug-in archive on the file system.

In some implementations, a plug-in class may declare the extension points it honors and offers in class constants. These declarations may then be read (e.g., using reflection) and authenticated by a plug-in management engine as it compiles metadata. While it may be useful in some instances to retain such definitions in the plug-in class, itself, a system so implemented may not scale well to support versioning, cardinality, and dependency relationships. In alternative implementations, a more complex plug-in management strategy may employ a single XML file per plug-in directory to describe relationships, version numbers, and other relevant data regarding plug-ins and their characteristics.

### Implementation

While the description set forth below addresses an embodiment that extends a flexible plug-in architecture to a ready-made command-line wrapper, it will be appreciated that the underlying principles have utility in various other applications including, but not limited to, graphical user interfaces (GUIs) and application programming interfaces (APIs).

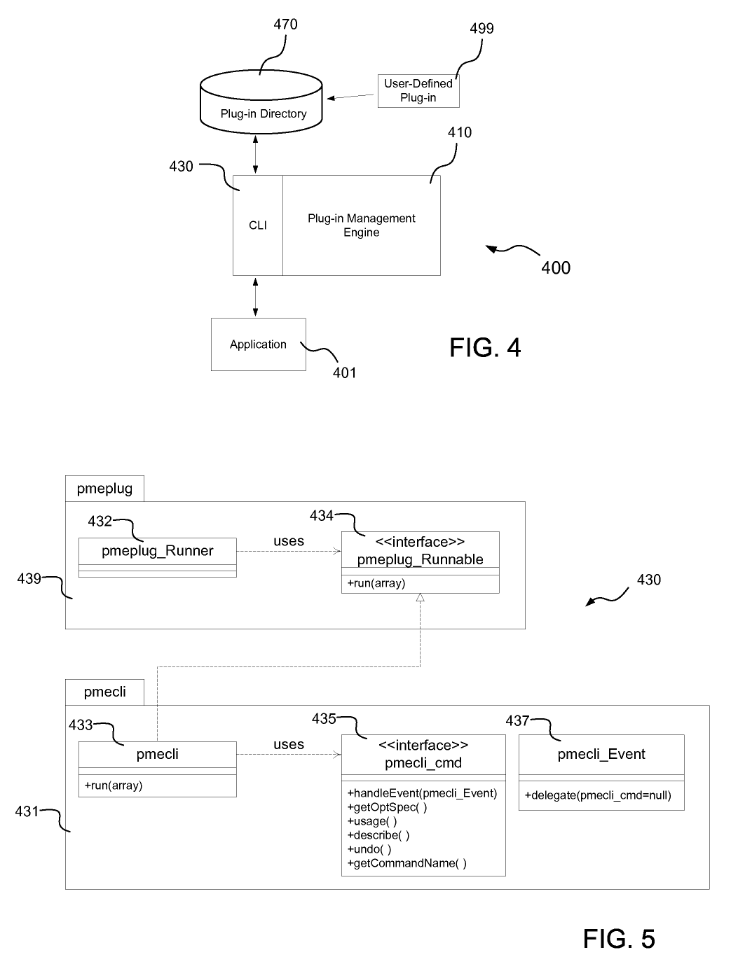

Turning now to FIGS. 4 and 5, FIG. 4 is a simplified block diagram illustrating one embodiment of a command-line interface system, and FIG. 5 is a simplified block diagram illustrating one embodiment of a command-line interface component employing extender components.

As indicated in FIG. 4, a command-line interface system 400 may generally comprise a plug-in management engine (PME) 410 cooperating with a command-line interface (CLI) 430. In operation, a computer program application 401 may be extended to employ functionality provided by plug-ins maintained in one or more directories, such as a plug-in directory 470; such extension may be facilitated by CLI 430 operating in accordance with functional characteristics managed, controlled, or otherwise affected by PME 410 as set forth in more detail below.

Directory 470 may be embodied in or comprise any suitable data store including, but not limited to: a hard disk or a RAID (redundant array of inexpensive disks) array; random access memory (RAM); flash memory; tape drives; optical, magneto-optical, or electro-optical drives; or a combination of these and other media capable of maintaining digital data in addressable locations. Directory 470 may organize stored data associated with plug-ins and their respective functionality in individual files or directory trees, for example, or in a database structure. The present disclosure is not intended to be limited by any particular file system or organizational structure implemented by directory 470.

As indicated in FIG. 4, directory 470 may receive data and instruction code associated with a user-defined plug-in 499 as described below; accordingly, those of skill in the art will appreciate that directory 470 may maintain a dynamic list of plug-ins and associated file, folder, or other directory structures associated with these plug-ins.

Application 401 may be of any type or nature; any application 401, irrespective of its purpose or core functions, that is suitably configured to interoperate with CLI 430 may employ the functionality provided by plug-ins maintained in directory 470 under the management of PME 410.

In that regard, PME 410 may generally be considered agnostic with respect to the operative characteristics of application 401 and the plug-ins maintained in directory 470. In operation, PME 410 may coordinate components of any kind, and may do so, in some embodiments, by enforcing contractual relationships between contracting (i.e., host and extender) components. As noted above, it may be desirable to establish the relationship between components in metadata, such as in an XML file, for instance. In such embodiments employing metadata, appropriate files and relevant data may be stored (and associated with relevant plug-ins) in directory 470; additionally or alternatively, directory 470 may provide address pointers or other appropriate indications of the location of such metadata when stored remotely. In operation, PME 410 may have access to sufficient information (such as a metadata file or other source (e.g., declarations in class constants)) regarding the relationship between components to determine extension points offered and honored by plug-ins extending application 401 or its extender plug-ins.

FIG. 5 illustrates certain details of a simplified embodiment of CLI 430. As depicted in the drawing figure, CLI 430 may generally comprise a plug-in management engine command-line interface (pmecli) component 431. In some respects, CLI 430 may be considered similar in concept to a package; CLI 430 and pmecli 431 represent a plug-in set, and as such, may generally comprise various plug-in classes, helper classes, and interfaces, as is generally known in the art. In some embodiments, CLI 430 and its various components may be integrated with, or “internal” to, PME 410, though it may also be implemented as a “stand-alone” component, i.e., independent of PME 410. In that regard, CLI 430 may be characterized alternatively as an integral component of PME 410 itself, or more generally as a set of plug-ins designed to operate in conjunction with PME 410. Accordingly, PME 410 may be agnostic with respect to the capabilities of CLI 430.

As indicated in FIG. 5, pmecli 431 may comprise various components, including but not limited to: a root pmecli plug-in component 433; a pmecli_cmd component 435; and a pmecli_Event component 437. In some embodiments, pmecli_cmd component 435 may be an interface (i.e., a class-like software component supported natively by the underlying programming language) that enforces the presence of core functions in implementing components (plug-ins). In this case, pmecli_cmd component 435 may be implemented to enforce functions that commands must or should provide in order to be recognized by CLI 430.

Those of skill in the art will recognize that pmecli component 433 is the root plug-in for CLI 430. In use, pmecli component 433 is the “socket” into which custom plug-ins, such as user-defined plug-in 499, may be plugged. In the FIG. 5 embodiment, pmecli_Event component 437 is a non-plug-in class that may be responsible for parsing user input (i.e., the CLI command invocation) and subsequently invoking corresponding plug-ins as set forth below.

FIG. 5 represents one simplified embodiment; CLI 430, pmecli 431, or both may include additional components. Operation of a pmeplug component 439 is discussed below with reference to FIG. 7. Additionally, various components of more complex embodiments of CLI 430 have been omitted from FIG. 5 for clarity. In some embodiments, for example, pmecli 431 may include a flag component, i.e., an interface that enforces functions that CLI flags should provide, as is generally known in the art. Additionally, CLI 430 may include or have access to a metadata component, e.g., pmeplug.xml. In this embodiment, CLI 430 may have necessary or appropriate access to metadata that define the relationship between host and extender plug-ins via extension points (i.e., named interfaces like “flag” and “cmd”). As an alternative, a pmeplug.xml metadata file may be maintained in directory 470 as set forth above, and CLI 430 may retrieve necessary or desired relationship information from directory 470 or from PME 410; the present disclosure is not intended to be limited to the location of these metadata.

In accordance with some embodiments, pmecli 431 may optionally include a partially implemented command class (e.g., pmecli_cmdlmpl, not shown in FIG. 5 for clarity). In operation, such a partially implemented command class may facilitate the process of creating a command class; this may have particular utility, e.g., with respect to parameterization because the partial implementation may be configured and operative to handle acquisition of description and argument data from an XML file or other source of relevant class data. The provision of a partial implementation may minimize the amount of preparatory work that otherwise might be required to create a class designed to fulfill the contract specified by pmecli_cmd component 435.

Returning to FIG. 4, it will be appreciated that directory 470 and user-defined plug-in 499 represent a system layer that is generally independent of PME 410 and CLI 430. In particular, components defined and stored in directory 470 may be developed by coders or software developers who design plug-ins to be compatible with the functionality of PME 410. For example, a software developer or engineer may design a new plug-in to comply with the requirements specified by pmecli component 433 and store the new plug-in in directory 470; PME 410, enforcing the contracts specified by CLI 430, may accordingly allow application 401 to employ the functionality of the newly designed plug-in (e.g., user-defined plug-in 499).

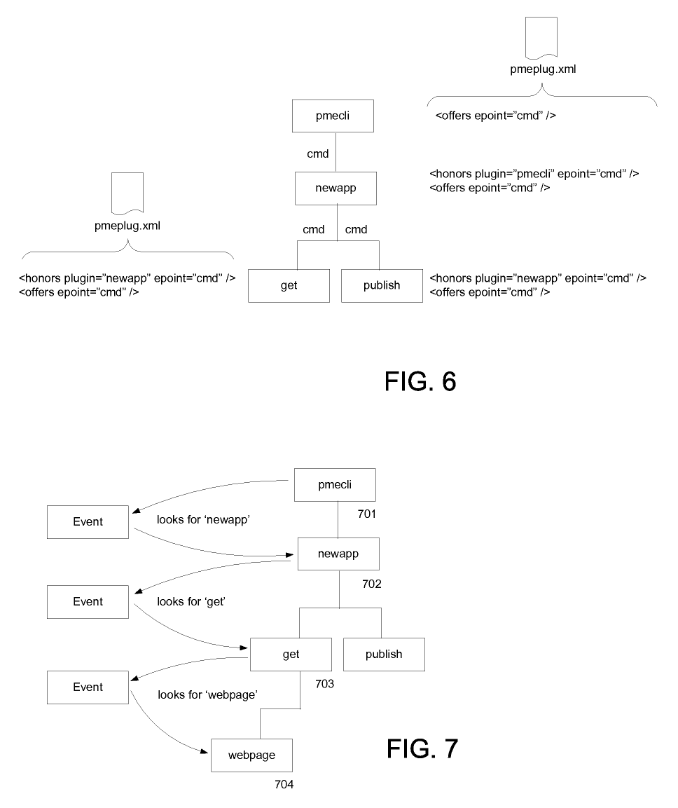

Developers need not be limited with respect to the type of plug-in intended to extend the functionality of application 401. For example, command plug-ins, flag plug-ins, and other types of plug-in functionality may be facilitated and supported by the interaction between CLI 430 and the contract enforcement functionality of PME 410, irrespective of the core functionalities or extension points defined by application 401, itself. Command plug-ins are components that generally represent commands as typed or entered on the CLI command-line, e.g., by a coder or software engineer. Command plug-ins typically honor a contract in two ways: first by implementing an interface, “cmd” (such as specified by pmecli_cmd component 435, for instance); and second, through use of metadata (e.g., by associating themselves with a host or extender plug-in via the same interface). In the foregoing manner, command plug-ins may be joined together into a tree structure as described below with reference to FIGS. 6 and 7.

Flag plug-ins are components that generally represent flags (e.g., ‘−w’, ‘−f’, etc) as entered on the CLI command-line, usually following a command to which they relate. Flags typically modify, alter, or otherwise influence the way that commands operate. In some embodiments, flag plug-ins may implement the “flag” interface (not shown in FIG. 5) and may additionally be associated with command plug-ins via metadata.

FIG. 6 is a simplified block diagram illustrating one embodiment of a plug-in architecture for use in conjunction with an extensible command-line interface. As depicted in FIG. 6, a software developer may design a simple application (labeled “newapp”) with two initial commands: “get;” and “publish.” Initially, the command components must be created (as is generally known in the art), and their relationship to the plug-in management engine command-line interface (i.e., pmecli 431 in FIG. 5) may be defined. As noted above, component definition and relationship specification may be accomplished with a special file, such as a metadata or XML file (represented by the document labeled “pmeplug.xml” in FIG. 6), or any other suitable type of file. As described above, a “cmd” extension point interface (component 435 in FIG. 5) may be predetermined in the pmecli 431 plug-in set, and may be reused any number of times as desired.

PME 410 generally enforces two related kinds of contracts that define plug-in relationships. As noted above, an extension point is a language construct called an “interface.” An interface may guarantee that an implementing class will have certain functions, however, an interface generally only enforces the functions a plug-in may provide to extend its host. PME 410, in conjunction with CLI 430, may be implemented to go a step beyond interface interoperability by enforcing contractual relationship between plug-ins as defined in metadata. In accordance with this architecture, as illustrated in FIG. 6, a plug-in not only fulfills an interface, it does so in order to attach to a host plug-in and to establish itself as another host plug-in lower down a tree structure. In the exemplary embodiments, PME 410 enforces these contracts behind the scenes, and is transparent both to application 401 and to the software engineer or other user.

The primary role of PME 410 may be regarded as that of identifying (or defining) and enforcing contracts and interrelationships between plug-ins that are evident from examination of the data stored in a metadata file such as “pmeplug.xml” illustrated in FIG. 6. Such a file may be provided for each set of plug-ins maintained in directory 470. Employing metadata and appropriate syntax, a plug-in can use an <offers> element, for example, to provide an extension point. A plug-in may be ensured of the capabilities of any extending plug-in because the extension point matches an interface honored by the extending plug-in; regulation and enforcement of these relationships may be guaranteed by PME 410. Through the <honors> element, a helper plug-in may commit to extend a host plug-in at a particular extension point; again, these relationships are enforced by PME 410.

In that regard, PME 410 may be implemented in a software package, for example, that is executable at runtime. When it compiles plug-ins, PME 410 may perform the following functions, without limitation: confirm that an interface exists corresponding to any invoked extension point; confirm that all host/extender plug-in components exist; compile components into a tree data structure; and provide an API for accessing components. In some embodiments, PME 410 may provide necessary or desired metadata or other information related to the interoperability of plug-ins to one or more components of CLI 430, for example, if requested or required.

In the FIG. 6 embodiment, the metadata file (pmeplug.xml) specifies that the root plug-in (pmecli component 433) of CLI 430 offers the “cmd” extension point; the application “newapp” honors this extension point, and offers its own “cmd” extension point. As indicated in the drawing figure, both the “get” and “publish” plug-ins honor the “cmd” plug-in offered by “newapp,” and in turn offer the same “cmd” extension point to extender plug-ins further down the tree. The illustrated structure ensures that all plug-ins will support core functionality defined by pmecli_cmd component 435, and enables a developer to create complicated applications extensible through plug-in functionality with only interpreted language skills, i.e., by creating a metadata file in XML or other simple non-compiled language and storing it in directory 470.

FIG. 7 is a simplified diagram illustrating execution of one embodiment of a command-line interface command. In the illustrated example, a user or software developer entered the command “newapp get webpage” into a CLI command-line at a terminal or computer. This argument list may be passed to CLI 430 and PME 410 by a small shell script, for example, or other common mechanisms generally known in the art. Following receipt of the command argument list, PME 410 may invoke a root command, i.e., pmecli 431 in FIG. 5; this invocation is represented at block 701 in FIG. 7. In turn, a root plug-in, pmecli component 433, may pass the argument list to a helper class, such as an Event component. As set forth above, pmecli_Event component 437 may be implemented as a non-plug-in class responsible for parsing user input, though other specialized components or combinations of components may also be employed.

The Event component may examine the argument list and parse the argument “newapp.” The Event component, cooperating with PME 410, may then identify an equivalent command plug-in (i.e., one that matches the argument “newapp”) attached to or associated with pmecli component 433. If located, a matching plug-in (in this case, the application “newapp”) may be invoked, as indicated at block 702 in FIG. 7. A portion of this process is illustrated by the dashed line in FIG. 5. A root plug-in, i.e., pmeplug_Runner 432, of a pmeplug component 439 may employ the pmeplug_Runnable interface 434 to identify a plug-in or application that has been designed and configured to operate in conjunction with PME 410. By way of example, a metadata file maintained at, associated with, or accessible by PME 410 may contain a list of all plug-ins, applications, or other components that are committed to interoperability with CLI 430. Upon instantiation, software code at or associated with PME 410 may invoke root plug-in pmeplug_Runner 432 to compile a list of qualified components that may access CLI 430. The Event component may parse this file to access relevant data regarding a component sought to be invoked by another component.

Returning to FIG. 7, the “newapp” command may execute in accordance with its instruction code, and may then hand back to the Event component when an additional plug-in is invoked at runtime. In the illustrated example, the Event component has been requested by “newapp” to locate the “get” plug-in. The Event component may then identify a command plug-in attached to or associated with “newapp” that matches the argument “get.” If located, the “get” plug-in may be invoked as indicated at block 703. In some embodiments, “newapp” may call a “delegate( )” method on the Event component (see, e.g., reference numeral 437 in FIG. 5). Having been called by “newapp” and having parsed the relevant command-line input argument, the Event component may then employ PME 410 to identify a valid plug-in that attaches to “newapp” and matches the argument in the command-line input. Such a delegation strategy may minimize the amount of work that might otherwise be required of a plug-in author.

The foregoing process may repeat until the entire argument list has been parsed or all arguments have been exhausted. In the example of FIG. 7, the “get” plug-in calls upon the Event component to identify a “webpage” plug-in, and the foregoing process may be utilized for this invocation (as indicated at block 704), and may be reiterated any number of times, depending upon the requirements of the “webpage” plug-in and any extender plug-ins honoring its “cmd” extension point.

Additionally, those of skill in the art will appreciate that a flag may be appended to the “newapp get webpage” command. For example, the flag “−jp” may be employed to translate output from “webpage” into Japanese; additionally or alternatively, a flag (such as “−s,” for instance) may be employed to invoke a speech plug-in to provide output from “webpage” in spoken words, for instance, employing an appropriate speech synthesis algorithm and attendant hardware. In embodiments in which only single character flags are supported, the forgoing multiple character flag may alternatively be expressed as a string of flags, i.e., “−j −p” may be substituted for “−jp.” If an implementation supports single character flags and also supports short-cuts, “−jp” may be recognized as a short-cut or alias for “−j −p.”

The foregoing plug-in strategy and invocation processes may be used to provide extensibility to “newapp” in various ways, and are not limited to any extension points that may be predefined or predetermined in the code for “newapp,” itself. Where a plug-in is stored in a known location and commits to honoring, as well as offering, the “cmd” extension point in the examples above, the plug-in may be suitable for extending “newapp” and the various components in its associated compatible plug-in tree.

In general, CLI commands must provide certain pieces of information (e.g., the argument string noted above) or functionality (e.g., as specified by flags). In operation, CLI 430 and PME 410 may employ or be compatible with various tactics generally known in the art to automate standard processes common in CLI development techniques. These include, for example: descriptions, i.e., textual information or documentation typically implemented in usage messages, are supported; plural aliases and abbreviations, i.e., the names a command answers to, are supported; argument specifications, i.e., the arguments the command accepts or expects, are supported that include symbols to indicate multiplicity (zero or more, etc.); and so forth.

Because PME 410 enforces interfaces, CLI 430 need not take measures to ensure that all commands will provide the expected information via functions.

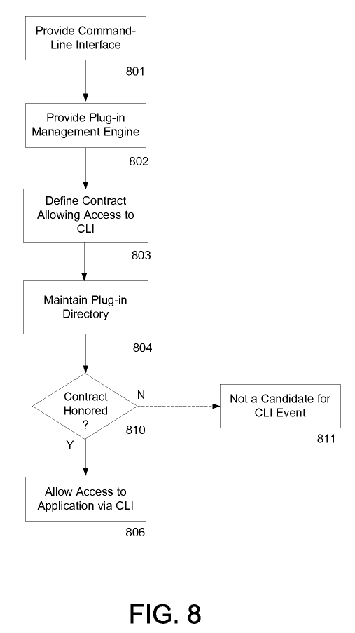

FIG. 8 is a simplified flow diagram illustrating operation of one embodiment of a method of implementing an extensible command-line interface. As indicated at block 801, a method may begin with providing a CLI (such as CLI 430); as is generally known in the art, a CLI may allow a user or software developer to interact with a computer application. As set forth above, a CLI may also be implemented to allow an application and a plug-in to interact in myriad ways if certain conditions or constraints are satisfied.

A plug-in management engine (such as PME 410) may be provided as indicated at block 802. As set forth in detail above, a plug-in management engine may be implemented to define and to enforce contracts between components such as, inter alia, host and extender plug-ins, for instance, and the CLI. In that regard, a contract that allows access to the CLI may be defined as indicated at block 803; in operation, the plug-in management engine may cooperate with CLI to ensure that all contracts are honored at defined extension points.

A directory of plug-ins (such as directory 470) may be maintained as indicated at block 804; various types of plug-ins (such as command and flag plug-ins, for example) may be stored in the directory, and user-defined plug-ins may be created and stored in the directory at any time as set forth above. Accordingly, maintenance of the plug-in directory may generally be considered an ongoing and dynamic process. In the illustrated embodiments described above, various of the plug-ins were designed to define additional functionality for a command-line application sought to be extended, though other types of applications may be extended through an extensible CLI.

When a component seeks to add a plug-in at an extension point during runtime, a determination may be made whether a suitable plug-in may be found in the directory that honors the contract required for access to the CLI (decision block 810). As set forth above, a plug-in management engine may enforce contracts that are specified, for example, in metadata. The plug-in management engine, cooperating with components of the CLI, for instance, may ensure that an extender plug-in both honors and offers a command extension point specified by a component of the CLI. In some embodiments, the relationship characteristics or host/extender status of a particular plug-in may readily be determined at decision block 810 using stored metadata or other information, e.g., declarations in class constants or other code sections.

Plug-ins honoring the contract (i.e., respecting the extension point offered by the CLI) may be allowed to interface with the command-line application through the CLI as indicated at block 806, whereas plug-ins that do not honor the contract may not be considered by the plug-in management engine as valid candidates for handling a CLI event (block 811). The access permitted at block 806 may be facilitated by or effectuated through various components of the CLI as described above with reference to FIGS. 6 and 7. It will be appreciated that if a plug-in were to break logic (e.g., by attempting to extend a non-existent parent, to use a non-existent interface, or to extend on an interface that the intended host does not offer), then the plug-in management engine may refuse to compile its tree and return an error.

The sequence and numbering of blocks depicted in FIG. 8 is not intended to imply an order of operations to the exclusion of other possibilities. For example, since maintenance of the plug-in directory is generally dynamic and ongoing as noted above, the operation depicted at block 804 may be occurring at various locations in FIG. 8, and generally simultaneously with all of the other operations. In some embodiments in which the CLI and the plug-in management engine are integrated, the operations depicted at blocks 801 and 802 may be effectuated substantially simultaneously.

Those of skill in the art will appreciate that the foregoing systems and methods are susceptible of various modifications and alterations. For example, with respect to parameterization, pmecli component 433 may provide default implementations for command and flag classes. These classes allow a developer or user to set help messages, as well as to provide documentation and other relevant information, in a metadata file so that desired or necessary information is contained in one easily accessible location. This feature may also enable one class to be used for different commands according to parameters set in XML or some other non-compiled programming language. With respect to flag handling, it is noted that flags may be parsed and managed in a similar manner as commands, substantially as set forth above. With respect to arguments, it is noted that commands can inform pmecli component 433 that they require arguments—PME 410 may enforce this constraint and make argument values available to relevant components.

PME 410 operating in conjunction with CLI 430 may simplify the creation of any command-line application. The systems and method set forth herein may allow an engineer with PHP skills to build and to extend applications that previously could only be built by a programmer skilled in more difficult languages like C. By allowing the engineer, developer, or other user to define extension points, these applications can be modified and expanded at will.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A method of extending a command-line application; said method comprising:
providing a plug-in management engine defining a contract that allows access to the command-line interface;
maintaining a directory of plug-ins that define additional functionality for the command-line application; and
allowing plug-ins that honor the contract to interface with the command-line application.

2. The method of claim 1 wherein said defining a contract comprises accessing a metadata file containing relationship information associated with the contract.

3. The method of claim 2 wherein the metadata file is an extensible Markup Language (XML) file.

4. The method of claim 2 wherein the metadata file contains a list of components that are committed to honoring the contract.

5. The method of claim 1 wherein said maintaining comprises storing a plug-in that is designed by a user.

6. The method of claim 5 wherein said maintaining further comprises storing a plug-in that has a user-defined extension point.

7. The method of claim 1 wherein said defining a contract comprises specifying a command interface.

8. The method of claim 1 wherein said allowing comprises enabling the plug-ins that honor the contract to offer an extension point representing the contract to extender plug-ins.

9. A command-line interface system comprising:
a plug-in management engine to define a contract that allows access to a command-line interface; said interface to allow access to a command-line application; and
a directory of plug-in components that define additional functionality for the application;
wherein said plug-in management engine allows plug-ins that honor the contract to extend the application through said interface.

10. The system of claim 9 wherein said plug-in management engine accesses a metadata file containing relationship information to define the contract.

11. The system of claim 10 wherein the metadata file is an extensible Markup Language (XML) file.

12. The system of claim 10 wherein the metadata file contains a list of components that are committed to honoring the contract.

13. The system of claim 9 wherein said directory stores a plug-in that is designed by a user.

14. The system of claim 13 wherein said directory stores a plug-in that has a user-defined extension point.

15. The system of claim 9 wherein the contract specifies a command interface.

16. The system of claim 9 wherein said plug-in management engine enables the plug-ins that honor the contract to offer an extension point representing the contract to extender plug-ins.

17. A computer-readable medium encoded with a computer-executable program to perform the method comprising:
providing a plug-in management engine defining a contract that allows access to the command-line interface;
maintaining a directory of plug-ins that define additional functionality for the command-line application; and
allowing plug-ins that honor the contract to interface with the command-line application.

18. The computer-readable medium of claim 17 wherein said defining a contract comprises accessing a metadata file containing relationship information associated with the contract.

19. The computer-readable medium of claim 18 wherein the metadata file is an extensible Markup Language (XML) file.

20. The computer-readable medium of claim 18 wherein the metadata file contains a list of components that are committed to honoring the contract.

21. The computer-readable medium of claim 17 wherein said maintaining comprises storing a plug-in that is designed by a user.

22. The computer-readable medium of claim 21 wherein said maintaining further comprises storing a plug-in that has a user-defined extension point.

23. The computer-readable medium of claim 17 wherein said defining a contract comprises specifying a command interface.

24. The computer-readable medium of claim 17 wherein said allowing comprises enabling the plug-ins that honor the contract to offer an extension point representing the contract to extender plug-ins.
